(19) United States
(12) Patent Application Publication
(10) Pub. No.: US 2024/0140185 A1
(43) Pub. Date: May 2, 2024

(54) ELECTRIC DRIVE VEHICLE CHASSIS

(71) Applicant: ZEVX Inc., Gilbert, AZ (US)

(72) Inventor: Damon Kuhn, Needville, TX (US)

(21) Appl. No.: 18/383,922

(22) Filed: Oct. 26, 2023

Related U.S. Application Data
(60) Provisional application No. 63/475,251, filed on Oct. 26, 2022.

(51) Int. Cl. B60K 1/02; B60K 17/16; B60K 17/22

(52) U.S. Cl. CPC B60K 1/02; B60K 17/16; B60K 17/22

(57) ABSTRACT

A chassis design for a commercial delivery vehicle is disclosed. The chassis design includes one or two forward mounted motor drives. The drive motors include a lateral drive motor and/or a longitudinal drive motor, such that the motors could drive one or both sets of wheels while maintaining most of the drive unit weight forward of the vehicle centerline to allow cargo carrying capacity similar to internal combustion engine configurations.

### CROSS-REFERENCE TO RELATED APPLICATION

This application claims the benefit of and priority to U.S. Provisional Patent Application Ser. 63/475,251, filed on Oct. 26, 2022, the contents of which are hereby incorporated by reference in its entirety.

### TECHNICAL FIELD

The present invention relates to a high efficiency electric drive chassis for a class B or higher commercial delivery vehicle. More specifically, the invention relates to a chassis design that is suitable to either replace existing designs or to be a convenient modification to existing chassis designs currently in use with Internal Combustion Engine (ICE) designs for class B (10,000 lb. or greater GCVW) and larger commercial style vehicles.

### BACKGROUND

Typical class B vehicles are primarily driven by gas or diesel engines, providing good vehicle range and providing a substantial cargo space located to the rear of the driver seat.

Many commercial delivery services are interested in moving to environmentally green approaches to vehicles, i.e., battery powered vehicles to replace the ICE vehicles currently in use.

Current attempts to provide an electric class B vehicle have not been commercially successful due to range and power limitations that are not conducive to their intended use. Range limitations are primarily a function of the portion of the vehicle that has been made available for placement of batteries. The commercial purpose of most class B vehicles is for making deliveries. This calls for a large cargo area rearward of the driver seat, preferably having a flat floor and the lowest possible floor height to facilitate ease of loading and unloading cargo as well as a large cargo holding capacity. However, the existing standard for electric vehicles is the ‘skateboard’ approach. This approach involves providing an array of batteries on a central portion of the vehicle chassis roughly midway between the front and rear axles. This placement of the battery array necessitates raising the floor of the cargo area sufficiently to accommodate the array of batteries beneath the floor of the cargo area. Raising the floor is inconsistent with the objective of providing a flat and low floor for the cargo area and it additionally reduces the cargo space. This has been an impediment to commercial acceptance. The trade-off has been to keep the battery array as small as possible, thus reducing the vehicles range, calling for frequent recharging of the battery array, and reducing the cargo space somewhat less than if a full battery array had been provided.

The existing electric vehicles suffer an additional disadvantage resulting from the skateboard approach. The largely flat floor surface rear of the driver precludes use of large drive motors for the rear wheels, thus limiting power available to the rear wheels. This is a contributing factor to meeting the commercially desirable power levels for class B (and larger) vehicles.

Attempts made to date have been largely dependent on raised floor heights and large front drive arrangements limiting industry acceptance.

The existing approaches have suffered from an additional disadvantage. The location of the batteries under the cargo floor undesirably places a large portion of the battery weight on the rear axle, thus limiting the carrying capacity of these vehicles. This too has been an impediment to commercial acceptance of these electric vehicles.

### SUMMARY

The chassis design of the present invention is primarily comprised of up to two electric drive motors. One of the two drive motors is a laterally arranged drive motor to drive the front wheels. This is optionally supplemented with a second longitudinally arranged electric motor to drive the rear wheels through a driveshaft/differential arrangement, similar to the drive components used in longstanding ICE rear-drive configurations. Alternatively, a single electric drive motor can be arranged to drive the rear wheels only.

According to the invention, the space previously occupied by the ICE engine peripherals is used for battery and control systems in a preferred embodiment.

For larger applications, batteries and peripheral hardware could also be mounted below the cab area and in tandem to the frame.

The front drive motor in the preferred embodiment uses a gear box/differential drive common to many current suppliers of electric vehicles while the rear drive may use the same or be directly coupled to a traditional rear differential taking advantage of existing ratios, thereby eliminating the need for a separate rear gearbox. This renders the present invention suitable for a retrofit application to convert existing ICE vehicles to electric power without completely redesigning the vehicle chassis.

Pursuant to an aspect, a chassis arrangement for a vehicle is disclosed. The chassis arrangement includes one or both of a lateral mounted electric motor drive unit for driving front wheels and a longitudinally mounted electric motor drive unit for driving rear wheels utilizing existing rear drivetrain. A forward or side mounted battery and control module is provided for powering the lateral mounted electric motor drive unit and/or the longitudinally mounted electric motor drive unit. The battery and control module is structured and arranged for keeping weight towards front of vehicle.

The lateral mounted electric motor drive unit may be arranged a front wheel hub centerline. Additionally or alternatively, the longitudinally mounted motor drive unit may be arranged forward of the driver seat of the vehicle. Additionally or alternatively, the forward or side mounted battery and control module is arranged forward of a driver seat of the vehicle.

Pursuant to another aspect, a chassis configuration for an electrically driven vehicle. The chassis configuration includes first and second electric drive motors and an array of electric batteries for providing primary drive energy for said vehicle. The first electric drive motor may be mounted laterally in said vehicle and forward of a driver seat for driving both left and right front wheels. The second electric drive motor may be mounted longitudinally in said vehicle and forward of the driver seat for driving both left and right rear wheels. The array of electric batteries may be mounted forward of said driver seat. The chassis configuration provides for electric motors that drive one or both sets of wheels while maintaining most of the drive unit weight forward of the vehicle centerline to allow cargo carrying capacity similar to internal combustion engine configurations.

Pursuant to an implementation, the first electric drive motor is disposed along a front wheel hub centerline. The first electric drive motor may include a gear reduction and differential drive.

A driveshaft may mechanically couple the second electric drive motor to a rear drive axle. The driveshaft may coupled to the rear drive axle via a differential and/or a gearbox.

Those skilled in the art will appreciate these mentioned features and advantages of the disclosure together with other important aspects upon reading the detailed description that follows in conjunction with the drawings provided.

### BRIEF DESCRIPTION OF THE DRAWINGS

While the claims are not limited to a specific illustration, an appreciation of the various aspects is best gained through a discussion of various examples thereof. Although the drawings represent illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows.

FIG. 1 is an overhead view of an electric drive vehicle chassis according to an example;

FIG. 2 illustrates a mounting apparatus suitable for positioning the electric drive chassis of FIG. 1 in a forward engine compartment of a vehicle.

### DETAILED DESCRIPTION

In the description that follows, the figures are not necessarily drawn to scale and may be shown in exaggerated or generalized form in the interest of clarity and conciseness.

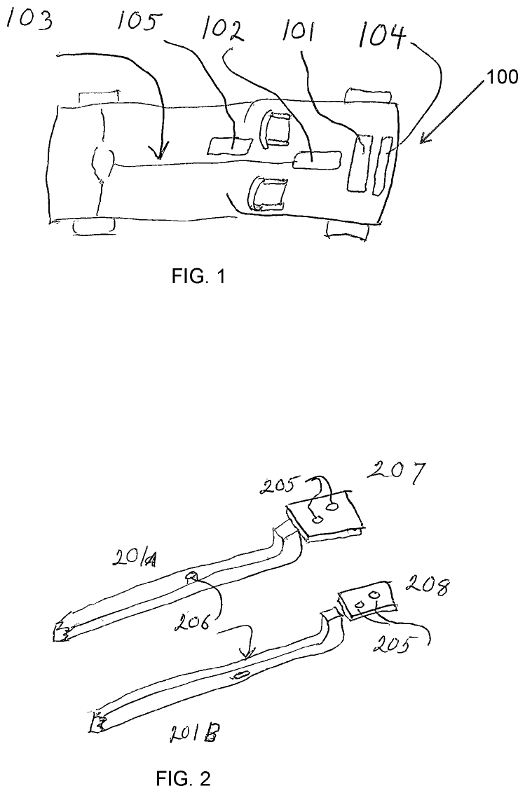

Referring to FIG. 1, an electric drive chassis 100 for a vehicle is shown. The chassis 100 is designed to replace existing ICE powered Class B and larger vehicles with an easily adaptable electric drive chassis. This system could also be made as a retrofit to existing vehicles.

Chassis 100 includes lateral motor 101, longitudinal motor 102, driveshaft 103 and battery/control modules 104/105.

Motor 101 is generally for front wheel drive. In a preferred embodiment, motor 101 is arranged in a lateral configuration such that it is centered on the front wheel hub centerline. Also in the preferred embodiment, the front motor drive would include a gear reduction and differential drive as one assembly.

Motor 102 is generally for rear wheel drive. In a preferred embodiment, motor 102 is longitudinally mounted, connected to a driveshaft 103, which extends to the vehicle rear differential coupled to the rear wheel drive axle. Depending on application requirements, this connection could be either directly connected or through a gearbox.

The motor 101 and/or the motor 102 may comprise, e.g., a DC motor such as a brushless DC (BLDC) motor. Alternatively, the motor 101 and/or the motor 102 may comprise a multi-phase AC motor (e.g., a three-phase AC motor).

Battery/control modules or boxes 104 and 105 may each comprise an array of electric batteries for providing primary drive energy for said vehicle together with power electronics for supplying electric power from the batteries to vehicle components, including at least the motor 101 and/or motor 102. The battery/control boxes 104, 105 are located in areas previously utilized for ICE engine peripherals. In the preferred embodiment, both areas are used. However, in alternative embodiments, one or both areas may be used depending on the necessary power requirements. The area preferred for boxes 104 and 105 is generally considered to be the engine compartment in prior chassis configurations.

In the preferred embodiment, both motors 101 and 102, as well as battery/control modules 103 and 104 are mounted in the forward area normally occupied by ICE engine and transmission in order to maintain load capacity of the vehicle. This area is forward of the driver seat.

Power converters (not shown), e.g., AC-DC power converters, may be employed as is known by skilled artisans, for converting DC power from the battery(ies) 103, 104 into AC power used by the motors 101, 102. The power converter(s) may be incorporated into the chassis 100, e.g., as part of the battery/control module 103, 104, or be supplied separately.

A controller (not shown), e.g., an electric control unit (ECU), may be electrically coupled (e.g., through lines or wirelessly) to the chassis components for controlling the motors 101, 102 as well as regulating the power output from battery/control modules 103, 104.

A particularly advantageous aspect of the present invention is that a standard mounting structure can be employed to position the electric motor and the batteries in the forward engine compartment such that the original weight and balance parameters of the vehicle can be maintained. With this desirable result, retrofit of an ICE vehicle is possible without requiring any modification of the service capabilities of the vehicle.

FIG. 2 illustrates a mounting apparatus suitable for positioning the electric drive system in the forward engine compartment, thereby retaining the original vehicle weight and balance to the greatest extent possible. This mounting apparatus includes a standard mounting protocol for a predetermined drive system design and is adapted to mate with any selected one of a set of brackets that are designed to interface with the specific engine mounting structure on the chassis of standard vehicles into which the electric drive system is to be retrofit.

In the embodiment illustrated in FIG. 2 support rails 201A and 201B include mounting plates 207 208 which may be either welded or bolted to the support rails 201A and 201B. Rails 201 may include suitable mounting locations 206 suitable for securing the electric Dr mechanism to the support rails and mounting structure 205 can be provided on the mounting plates to facilitate the convenient bolting of the electric Dr unit into the vehicle that is being retrofit for electric drive.

The predetermined drive system design is structured in an efficient manner that will be broadly applicable to a wide range of ICE vehicles and will accommodate the convenient substitution of electric power for ICE power. Once the drive system configuration is established the design of the support structure can be pursued to be sure it is within the pre-existing physical size of the engine compartments of a selected plurality of ICE vehicles. In this manner it is possible to have a straightforward substitution of electric drive in place of ICE drive.

It will be appreciated by those skilled in the art that the chassis is designed to be used in many vehicle configurations and the drawing is representative of one possible preferred embodiment. The configuration may be used with other chassis types, including class A or class 3 vehicles with only minor modifications for fitment. Likewise, the preferred embodiments are described for use with current normal vehicle loading. However, in special cases, embodiments for use in lighter or heavier vehicles may use larger, smaller or even single motors. It will be further appreciated that more than two drive motors may be provided without departing from the scope of the disclosure. For example, two lateral drive motors may be provided to drive the front wheels (e.g., each front wheel has a dedicated drive motor). Additionally or alternatively, two longitudinal drive motors may be provided to drive the rear wheels (e.g., each rear wheel has a dedicated drive motor). Likewise, other changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that a computer and/or a processor (e.g., controller or ECU) as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

An electronic controller and/or an electronic processor may include a programmable microprocessor and/or microcontroller, such as an application specific integrated circuit (ASIC). The controller may include or communicate with a memory (e.g., a non-transitory computer-readable storage medium, and/or an input/output (I/O) interface. The controller may be configured to perform various functions, including those described in greater detail herein, with appropriate programming instructions and/or code embodied in software, hardware, and/or other medium.

What is claimed is:

1. A chassis arrangement for a vehicle, comprising:
one or both of a lateral mounted electric motor drive unit for driving front wheels and a longitudinally mounted electric motor drive unit for driving rear wheels utilizing existing rear drivetrain; and
a forward or side mounted battery and control module keeping weight towards front of vehicle.

2. The chassis arrangement of claim 1, comprising both the lateral mounted electric motor drive unit and the longitudinally mounted electric mot drive, wherein the lateral mounted electric motor drive unit is arranged a front wheel hub centerline.

3. The chassis arrangement of claim 1, wherein the forward or side mounted battery and control module is arranged forward of a driver seat of the vehicle.

4. A chassis configuration for an electrically driven vehicle, comprising: first and second electric drive motors and an array of electric batteries for providing primary drive energy for said vehicle,
a. said first electric drive motor being mounted laterally in said vehicle and forward of a driver seat for driving both left and right front wheels,
b. said second electric drive motor being mounted longitudinally in said vehicle and forward of the driver seat for driving both left and right rear wheels, and
c. said array of electric batteries being mounted forward of said driver seat.

5. The chassis configuration of claim 4, wherein said first electric drive motor is disposed along a front wheel hub centerline.

6. The chassis configuration of claim 4, wherein the first electric drive motor includes a gear reduction and differential drive.

7. The chassis configuration of claim 4, further comprising a driveshaft that mechanically couples the second electric drive motor to a rear drive axle.

8. The chassis configuration of claim, wherein the driveshaft is coupled to the rear drive axle via a differential and a gearbox.
